(19) United States
(12) Patent Application Publication
(10) Pub. No.: US 2011/0249216 A1
(43) Pub. Date: Oct. 13, 2011

(54) LIQUID CRYSTAL DISPLAY DEVICE

(75) Inventors: Nobuyuki Nakamura, Osaka (JP); Tetsuya Umehara, Osaka (JP); Yoshitomo Suzuki, Osaka (JP); Hiromitsu Fujinami, Osaka (JP)

(73) Assignee: SHARP KABUSHIKI KAISHA, Osaka (JP)

(21) Appl. No.: 13/139,505

(22) PCT Filed: Dec. 7, 2009
(86) PCT No.: PCT/JP2009/070470

§ 371 Date: Jun. 13, 2011

(30) Foreign Application Priority Data
Dec. 19, 2008 (JP) 2008-324341

(51) Int. Cl. G02F 1/1335

(52) U.S. Cl. 349/61

(57) ABSTRACT

A liquid crystal panel (2) is equipped with a first transparent substrate (21) on which a TFT is formed, a second transparent substrate (22), and a liquid crystal layer (23) interposed therebetween. An illumination device is disposed on the first transparent substrate side of the liquid crystal panel. When viewed along the normal direction of the primary surfaces of the first and second transparent substrates, a portion of the first transparent substrate protrudes beyond the second transparent substrate and a portion of the second transparent substrate protrudes beyond the first transparent substrate. The portion of the second transparent substrate which protrudes beyond the first transparent substrate is supported by a support part (41). Thus, it is possible to reduce display anomalies generated when pressure is applied to the display screen by a finger or the like.

### TECHNICAL FIELD

The present invention relates to a liquid crystal display device.

### BACKGROUND ART

In electronic devices such as mobile information terminals represented by a PDA, for example, a liquid crystal display device with a touch panel is widely used. A schematic structure of a conventional liquid crystal display device with a touch panel is shown in FIG. 5A (see Patent Document 1, for example).

A liquid crystal display device with a touch panel 100 shown in FIG. 5A is equipped with a touch panel 110, a liquid crystal panel 120, and an illumination device 130 for illuminating the liquid crystal panel 120 in this order.

The liquid crystal panel 120 is equipped with a first glass substrate 121 and a second glass substrate 122 disposed in parallel with each other, a liquid crystal layer 123 interposed between the first and second glass substrates 121 and 122, and a sealing member 124 for sealing the liquid crystal layer 123. The first glass substrate 121 is disposed on the illumination device 130 side of the liquid crystal layer 123, and the second glass substrate 122 is disposed on its opposite side. The touch panel 110 is placed on the side opposite to the liquid crystal layer 123 side of the second glass substrate 122.

The illumination device 130 includes a light source 131 that generates illuminating light, and a light guide plate 132 that diffuses light from the light source 131 and emits the light toward the liquid crystal panel 120. The illumination device 130 is disposed within a chassis 140.

By making the first glass substrate 121 of the liquid crystal panel 120 larger than the second glass substrate 122, and by bonding the outer peripheral area of the first glass substrate 121 that protrudes beyond the second glass substrate 122 to a rectangular frame-shaped upper surface 141 that surrounds the light guide plate 132 of the chassis 140 using a double-sided adhesive tape 142, the liquid crystal panel 120 is fixed on the chassis 140.

A user can see an image displayed on the liquid crystal panel 120 through the touch panel 110, and can input desired information by touching a surface of the touch panel 110 with a finger, an input pen or the like.

### RELATED ART DOCUMENTS

### Patent Documents

Patent Document 1: Japanese Patent Application Laid-Open Publication No. 2007-102565

### SUMMARY OF THE INVENTION

### Problems to be Solved by the Invention

In a conventional liquid crystal display device 100 with a touch panel shown in FIG. 5A, a chassis 140 supports a first glass substrate 121. That is, a structure including the liquid crystal panel 120 and the touch panel 110 laminated thereon is supported through the first glass substrate 121.

As shown in FIG. 5B, when a pressure F is added to the touch panel 110 by a finger 150, for example, the pressure F is conveyed to the second glass substrate 122 located below the touch panel 110. As a result, the second glass substrate 122 bends locally in the area near the point where the pressure F was applied. As a result, the thickness of the liquid crystal layer 123 changes, and the liquid crystal orientation becomes disorderly, thereby creating a problem of wavelike display anomalies that occur near the point where the pressure F was applied.

Further, because of a structure in which the pressure F is supported through the second glass substrate 122, the sealing member 124, the first glass substrate 121, and the double-sided adhesive tape 142 in this order, the thickness of the liquid crystal layer 123 changes near the sealing member 124, and the liquid crystal orientation becomes disorderly there, thereby creating a problem of wavelike display anomalies that occur in a part of the outer peripheral area or in the entire outer peripheral area of the display screen.

A user could touch the screen even in a liquid crystal display device without a touch panel, and if wavelike display anomalies described above occur in that case, a user feels discomfort and the product value is lowered.

In recent years, there has been a strong demand for thinner and lighter liquid crystal panels. If the first and second glass substrates 121 and 122 are made thinner in order to meet this demand, the above-mentioned problems occur more prominently.

An object of the present invention is to solve the above-mentioned problems in the conventional art, and to reduce display anomalies that occur when pressure is applied to the display screen by a finger or the like.

### Means for Solving the Problems

A liquid crystal display device of the present invention includes a liquid crystal panel that includes a first transparent substrate having TFTs formed on at least one of surfaces thereof, a second transparent substrate that faces the aforementioned first transparent substrate, and a liquid crystal layer interposed between the first transparent substrate and the second transparent substrate; an illumination device disposed on a side of the first transparent substrate of the liquid crystal panel; and a support part that holds the aforementioned liquid crystal panel.

When viewed in a direction normal to the primary surfaces of the aforementioned first and second transparent substrates, a portion of the first transparent substrate protrudes beyond the second transparent substrate, and a portion of the second transparent substrate protrudes beyond the first transparent substrate. The portion of the second transparent substrate protruding beyond the first transparent substrate is supported by the aforementioned support part.

### Effects of the Invention

According to the present invention, a liquid crystal panel is supported through the second transparent substrate placed on the visible side of a liquid crystal layer. Therefore, by making the second transparent substrate thicker, wavelike display anomalies that occur near the pressure-applied point can be reduced. Moreover, by making the first transparent substrate thin so as to follow the warp of the second transparent substrate, it is possible to reduce wavelike display anomalies that occur in a part of the outer peripheral area or in the entire outer peripheral area of the display screen when pressure is applied.

### BRIEF DESCRIPTION OF THE DRAWINGS

FIG. 1 is a perspective view showing a schematic structure of a liquid crystal display according to an embodiment of the present invention.

FIG. 2 is a cross-sectional view of a liquid crystal display device according to an embodiment of the present invention, showing a surface parallel to the thickness direction including the line II-II of FIG. 1.

FIG. 3 is a cross-sectional view of a liquid crystal display device according to an embodiment of the present invention, showing a surface parallel to the thickness direction including the line III-III of FIG. 1.

FIG. 4 is a plan view showing a schematic structure of a liquid crystal display device according to an embodiment of the present invention.

FIG. 5A is a cross-sectional view showing a schematic structure of a conventional liquid crystal display device with a touch panel, and FIG. 5B is a cross-sectional view showing the behavior of the conventional liquid crystal display device with a touch panel shown in FIG. 5A when it is touched by a finger.

### DETAILED DESCRIPTION OF EMBODIMENTS

In the above-mentioned liquid crystal display device of the present invention, it is preferable that a driver member for driving the aforementioned liquid crystal panel be installed in the portion of the aforementioned first transparent substrate that protrudes beyond the aforementioned second transparent substrate. With this structure, it is possible to follow a basic design of a conventional liquid crystal display device, and to perform the production and inspection of a liquid crystal panel in a manner nearly identical to the conventional way.

It is preferable that the aforementioned second transparent substrate be thicker than the aforementioned first transparent substrate. With this structure, without increasing the entire thickness of a liquid crystal panel, display anomalies that occur when pressure is applied to a display screen can be reduced.

It is preferable that the aforementioned first transparent substrate and the aforementioned illumination device be apart from each other. With this structure, it is possible to further reduce the occurrence of display anomalies. Moreover, even if an environmental change occurs, the liquid crystal panel and the illumination device do not interfere with one another, and they each can change in dimension freely.

A touch panel may be installed on a side opposite to the aforementioned liquid crystal layer side of the aforementioned second transparent substrate. With this structure, it is possible to realize a liquid crystal display device in which information input is enabled. Furthermore, because the occurrence of display anomalies due to the applied pressure is suppressed, it is possible to achieve a liquid crystal display device with a smaller thickness and lighter weight at lower cost, while improving the product value, as compared to conventional liquid crystal display devices with a touch panel.

A liquid crystal display device of the present invention is described below using preferred embodiments. The attached figures are conceptually illustrated in order for viewers to easily understand the invention, and the dimensions and the dimensional ratios of respective parts shown in the figures do not match those of actual devices.

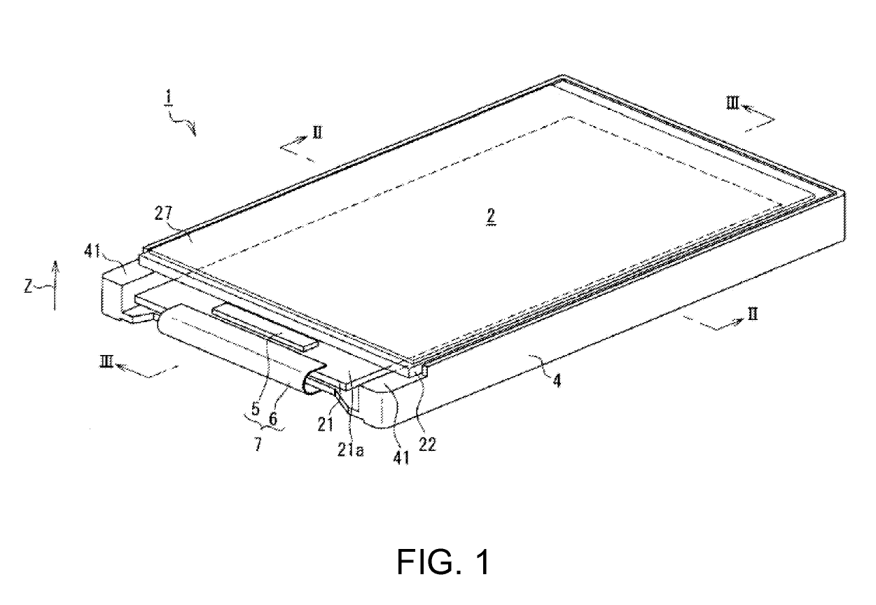

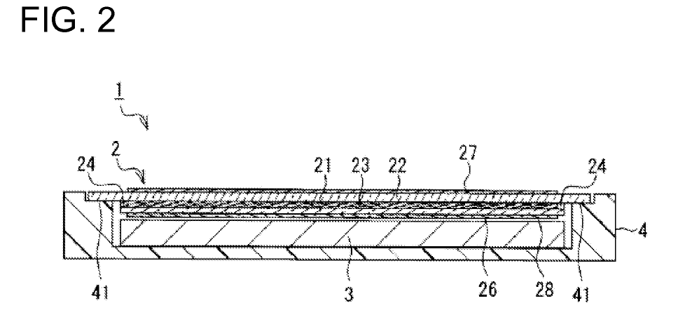

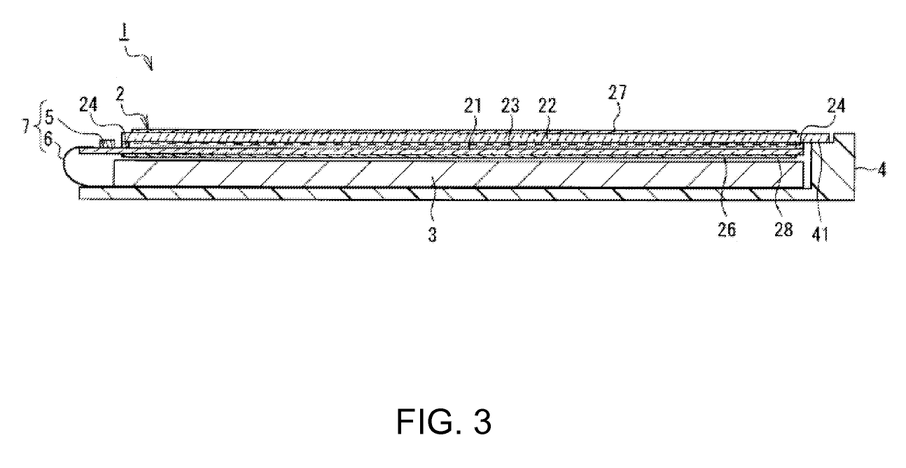

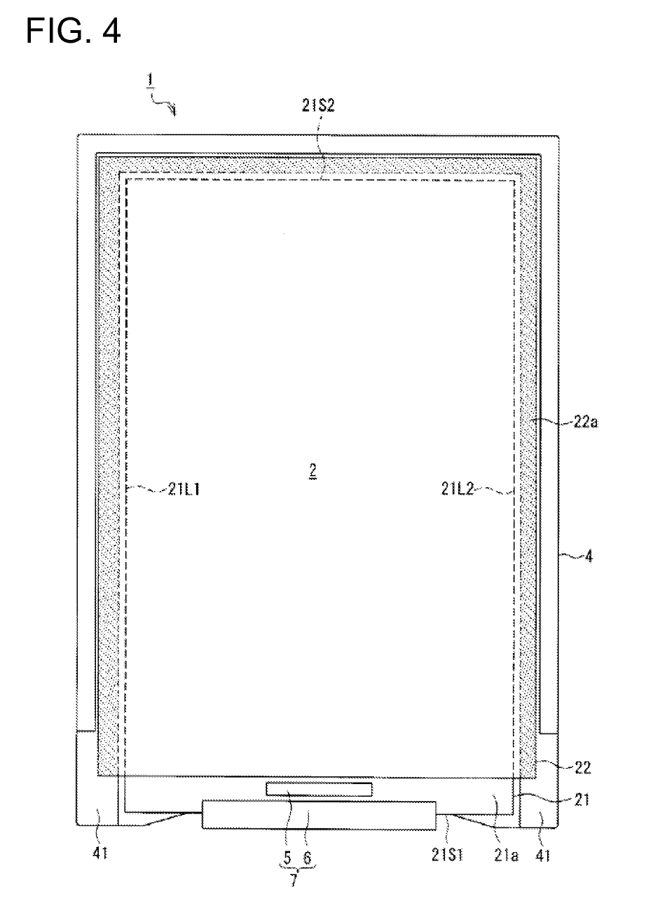

FIG. 1 is a perspective view showing a schematic structure of a liquid crystal display device 1 of one embodiment of the present invention. For convenience of description, an axis in parallel with the thickness direction of the liquid crystal display device 1 is called an axis Z. The arrow of the axis Z is directed toward the visible side of the liquid crystal display device 1. FIG. 2 is a cross-sectional view of the liquid crystal display device 1, showing a surface parallel with the axis Z including the line II-II of FIG. 1. FIG. 3 is a cross-sectional view of the liquid crystal display device 1, showing a surface parallel with the axis Z including the line III-III of FIG. 1. FIG. 4 is a plan view of the liquid crystal display device 1.

The liquid crystal display device 1 of the present embodiment is equipped with a transmissive liquid crystal panel 2, an illumination device 3 that illuminates the liquid crystal panel 2, and a chassis 4.

The liquid crystal panel 2 includes a first transparent substrate 21 and a second transparent substrate 22 disposed in parallel with each other, and a liquid crystal layer 23 interposed between the first and second transparent substrates 21 and 22. The first transparent substrate 21 is disposed on the illumination device 3 side of the liquid crystal layer 23, and the second transparent substrate 22 is disposed on the opposite side. The first and second transparent substrates 21 and 22 are both a plate-like member. There is no specific limitation for the material of the first and second transparent substrates 21 and 22, and the same materials as the ones used for a conventional liquid crystal panel, such as glass and acrylic resin, can be used. The liquid crystal layer 23 is sealed with a sealing member 24 placed between the first and second transparent substrates 21 and 22. On a surface of the first transparent substrate 21 facing the liquid crystal layer 23, although not shown in the figures, TFTs (Thin Firm Transistors), pixel electrodes, an alignment film and the like are formed by known methods. Moreover, on a surface of the second transparent substrate 22 facing the liquid crystal layer 23, although not shown in the figures, a color filter, a transparent electrode, an alignment film and the like are formed by known methods. A first polarizing plate 26 is laminated on a surface opposite to the liquid crystal layer 23 side of the first transparent substrate 21, and a second polarizing plate 27 is laminated on a surface opposite to the liquid crystal layer 23 side of the second transparent substrate 22.

As shown in FIG. 4, when viewing the liquid crystal display device 1 in a direction normal to the primary surfaces of the first and second transparent substrates 21 and 22 (that is, the direction of the axis Z), a portion 21a including a short side 21S1 on one side of the first transparent substrate 21 protrudes beyond the second transparent substrate 22. Further, the second transparent substrate 22 protrudes beyond the other short side 21S2, and a pair of long sides 21L1 and 21L2 of the first transparent substrate 21. Furthermore, in FIG. 4, in order to simplify the figure, the second polarizing plate 27 laminated on the second transparent substrate 22 is not shown.

In the protruding portion 21a of the first transparent substrate 21 protruding beyond the second transparent substrate 22, a driver member 7 made of a driver 5 for driving the liquid crystal panel 2 (LSI for driving), a flexible printed circuit (FPC) 6 for transferring signals from/to the driver 5 and the like is installed on a surface of the same side on which the above-mentioned TFT and the like is formed.

Meanwhile, the protruding portion of the second transparent substrate 22 protruding beyond the first transparent substrate 21 is supported by a support part 41 of a chassis 4, as shown in FIG. 2 and FIG. 3. In order to fix the second transparent substrate 22 onto the support part 41, an adhesive agent, a double-sided adhesive tape or the like may be used between them. In FIG. 4, the dotted area 22a substantially in the shape of “U” shows the area of the second transparent substrate 22 supported by the support part 41 of the chassis 4.

As shown in FIG. 2 and FIG. 3, the illumination device 3 is fixed to the chassis 4. There is no special limitation for the illumination device 3, and an illumination device known to public as an illumination device for a liquid crystal display device can be used. For example, a direct lighting device or an edge-light type illumination device can be used, and an edge-light type illumination device is especially preferable because it is advantageous when making a liquid crystal display device thinner. Moreover, there is no limitation for the kind of a light source, and cold-/hot-cathode tubes, an LED or the like may be used, for example.

The effects of the present embodiment in the above-mentioned configuration are described as follows.

In the present embodiment, a portion of the second transparent substrate 22 disposed on the visible side protrudes beyond the outer peripheral edge of the first transparent substrate 21. Further, by supporting the protruding portion of the second transparent substrate 22 by the support part 41 as shown in FIG. 2 and FIG. 3, the liquid crystal panel 2 is fixed to the chassis 4. In other words, it has a structure in which pressure applied to the display screen by a finger or the like is supported through the second transparent substrate 22. The first transparent substrate 21 does not contribute to the support of the liquid crystal panel 2 by the support part 41 in any way.

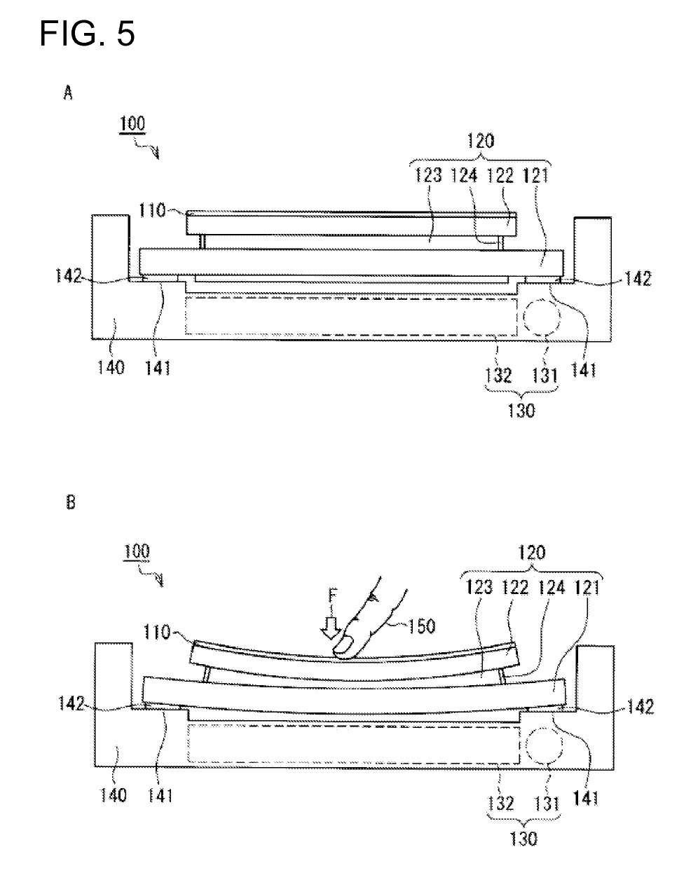

Therefore, for example, by improving the mechanical strength by making the second transparent substrate 22 thicker than a conventional liquid crystal display device (see FIG. 5A), it is possible to reduce a partial change in shape of the second transparent substrate 22 caused by pressure. As a result, the change in thickness of the liquid crystal layer 23 near the pressure-applied point is reduced, and therefore, it is possible to solve a conventional problem of wavelike display anomalies occurring near the pressure-applied point.

Further, in the present embodiment, the first transparent substrate 21 is only held by the second transparent substrate 22 through the sealing member 24 or the like, and therefore, no high mechanical strength is required. Therefore, it is possible to make the first transparent substrate 21 thinner than a conventional liquid crystal display device (see FIG. 5A). For example, the first transparent substrate 21 can be thinner than the second transparent substrate 22. If the first transparent substrate 21 is made thinner, when the entire second transparent substrate 22 bends due to pressure, the first transparent substrate 21 also bends following this warp. Accordingly, the change in thickness of the liquid crystal layer 23 is reduced across the entire display screen, as compared to conventional devices. As a result, it is possible to solve a conventional problem of wavelike display anomalies occurring in a part of the outer peripheral area or in the entire outer peripheral area of the display screen caused by an applied pressure.

In a conventional liquid crystal display device, as shown in FIG. 5B, when a pressure F is applied, the second glass substrate 122 bends more than the first glass substrate 121 does. Therefore, stress caused on a sealing member 124 becomes large, causing a problem of separation between the sealing member 124 and the first or second glass substrates 121,122. On the other hand, in the present embodiment, the first transparent substrate 21 bends following the warp of the second transparent substrate 22, and therefore, stress caused on the sealing member 24 is small. Accordingly, it is possible to solve a problem of separation between the sealing member 24 and the first or second transparent substrates 21, 22 as well.

Furthermore, it is possible to make the first transparent substrate 21 thinner while making the second transparent substrate 22 thicker, and therefore, the entire thickness of the liquid crystal panel 2 itself does not increase.

When viewed along the direction of the axis Z, the portion 21a of the first transparent substrate 21 protrudes beyond the second transparent substrate 22. As shown in FIG. 1, FIG. 3, and FIG. 4, the driver member 7 made of the driver 5, the flexible printed circuit 6 and the like can be installed on a surface of this protruding portion 21a on which TFTs and the like are formed. Therefore, it is possible to keep a basic design of conventional liquid crystal display devices, in which a transparent substrate having TFTs thereon is disposed on the illumination device side, in the present invention as well. Furthermore, the production and inspection of a liquid crystal panel can be performed in a manner almost identical to the conventional way.

As shown in FIG. 2 and FIG. 3, it is preferable that the first transparent substrate 21 and the illumination device 3 be apart from each other. With this structure, even the first and second transparent substrates 21 and 22 bend when pressure is applied, the first transparent substrate 21 does not come in contact with the illumination device 3. Accordingly, because change in thickness of the liquid crystal layer 23 that would occur when the first transparent substrate 21 comes in contact with the illumination device 3 does not occur, it is possible to further suppress the occurrence of wavelike display anomalies. Moreover, because the first transparent substrate 21 and the illumination device 3 are apart from one another, when environment such as temperature and humidity changes, the liquid crystal panel 2 and the illumination device 3 do not interfere with each other, and they each can change in dimension freely. A gap 28 between the first transparent substrate 21 and the illumination device 3 can be determined in consideration of the degree of change in shape of the first and second transparent substrates 21 and 22 caused by pressure applied to the liquid crystal panel 2, and the amount of dimensional change, warp degree and the like of members constituting the liquid crystal panel 2 and illumination device 3 caused by environmental changes.

The above-mentioned embodiment illustrates the present invention by way of example, and the present invention is not limited to these, and various modifications are possible.

For example, a touch panel may be installed on the side opposite to the liquid crystal layer 23 of the second transparent substrate 22. With this structure, the liquid crystal display device can be used as an information input device as well. There is no special limitation for the touch panel, and a touch panel known to public can be appropriately selected and used, or such touch panel can be used after adding necessary changes. For example, a resistive film type touch panel is preferable because the detection accuracy is high, the structure is simple, and the cost is low. In the present invention, because the occurrence of display anomalies due to an applied pressure is suppressed, it is possible to dispose a touch panel in close contact with the liquid crystal panel 2 (more specifically, the second polarizing plate 27, for example). In this case, it is not necessary to use methods conventionally used widely in order to make it harder for pressure applied to a touch panel to be conveyed to a liquid crystal panel, such as a method of placing a spacer or the like between a touch panel and a liquid crystal panel to separate them and a method of placing a cushion material between a touch panel and a liquid crystal panel. Therefore, it becomes possible to reduce the thickness and the weight, and to reduce the cost of a liquid crystal display device by reducing the number of parts and manufacturing steps, and the like.

The present invention is not limited to the above-mentioned embodiments in terms of which portion of the first transparent substrate 21 protrudes beyond the second transparent substrate 22, and which portion of the second transparent substrate 22 protrudes beyond the first transparent substrate 21 when viewed in the direction of the axis Z, and they can be appropriately determined. However, it is preferable that the size of the protruding portion 21a of the first transparent substrate 21 that protrudes beyond the second transparent substrate 22 be kept to a minimum degree that is necessary to equip the driver member 7 for driving the liquid crystal panel. This is because that way, the area supporting the liquid crystal panel 2 can be increased.

The shape of the first and second transparent substrates 21 and 22 when viewed along the direction of the axis Z does not need to be a rectangular shape described in the above-mentioned embodiments, and it may be in other appropriate shapes.

The driver members equipped in the protruding portion of the first transparent substrate 21 protruding beyond the second transparent substrate 22 are not limited to the driver 5 and the flexible printed circuit 6 described in the above-mentioned embodiments, and known members which were equipped in conventional liquid crystal display devices for driving a liquid crystal panel can be used, for example.

In the above-mentioned embodiments, the support part 41 supporting the second transparent substrate 22 is integrally formed with the chassis 4 that has an illumination device 3, but the support part 41 may be a separate member from the chassis 4, for example. Moreover, a structure in which the support part 41 sandwiches both sides of the second transparent substrate 22 is also acceptable. Furthermore, an adhesive agent, a double-sided adhesive tape, a buffer material or the like may also be used between the support part 41 and the second transparent substrate 22.

### INDUSTRIAL APPLICABILITY

There is no special limitation to applicable fields of the present invention, but the present invention can preferably be applied to a display device of various electronic devices on which a touch panel is laminated, for example, because display anomalies caused by pressure applied to a liquid crystal panel are less likely to occur.

### DESCRIPTION OF REFERENCE CHARACTERS

1 liquid crystal display device
2 liquid crystal panel
21 first transparent substrate
21a protruding portion
21S1, 21S2 short side of a first transparent substrate
21L1, 21L2 long side of a first transparent substrate
22 second transparent substrate
22a supported area
23 liquid crystal layer
24 sealing member
26 first polarizing plate
27 second polarizing plate
28 gap
3 illumination device
4 chassis
41 support part
5 driver (LSI for driving)
6 flexible printed circuit (FPC)
7 driver member

1. A liquid crystal display device, comprising:
a liquid crystal panel that includes a first transparent substrate having TFTs formed on at least one of surfaces thereof, a second transparent substrate that faces said first transparent substrate, and a liquid crystal layer interposed between said first transparent substrate and said second transparent substrate;
an illumination device disposed on a side of said first transparent substrate of said liquid crystal panel; and
a support part that holds said liquid crystal panel,
wherein when viewed in a direction normal to primary surfaces of said first and second transparent substrates, a portion of said first transparent substrate protrudes beyond said second transparent substrate, and a portion of said second transparent substrate protrudes beyond said first transparent substrate, and
wherein the protruding portion of said second transparent substrate protruding beyond said first transparent substrate is supported by said support part.

2. The liquid crystal display device according to claim 1, further comprising a driver member for driving said liquid crystal panel installed in the protruding portion of said first transparent substrate that protrudes beyond said second transparent substrate.

3. The liquid crystal display device according to claim 1, wherein said second transparent substrate is thicker than said first transparent substrate.

4. The liquid crystal display device according to claim 1, wherein said first transparent substrate and said illumination device are apart from each other.

5. The liquid crystal display device according to claim 1, further comprising a touch panel installed on a side opposite to said liquid crystal layer of said second transparent substrate.
